(19) United States
(12) Patent Application Publication
(10) Pub. No.: US 2025/0192281 A1
(43) Pub. Date: Jun. 12, 2025

(54) THERMAL BARRIER SHIELDS FOR USE WITHIN TRACTION BATTERY PACKS

(71) Applicant: FORD GLOBAL TECHNOLOGIES, LLC, Dearborn, MI (US)

(72) Inventors: Patrick ROXIN, Livonia, MI (US); Mohammadreza EFTEKHARI, Novi, MI (US); Michael E. REIBLING, Sterling Heights, MI (US); Kanchana PERUMALLA, Troy, MI (US); Karen SILER, Commerce Township, MI (US); Joseph FRICANO, Canton, MI (US)

(21) Appl. No.: 18/634,328

(22) Filed: Apr. 12, 2024

Related U.S. Application Data
(60) Provisional application No. 63/607,888, filed on Dec. 8, 2023.

(51) Int. Cl. H01M 10/658; B60L 50/64; H01M 50/209; H01M 50/271; H01M 50/291; H01M 50/293

(52) U.S. Cl. CPC H01M 10/658; B60L 50/64; H01M 50/209; H01M 50/271; H01M 50/291; H01M 50/293; H01M 2220/20

(57) ABSTRACT

Thermal barrier shields are provided for traction battery packs. The thermal barrier shield may be arranged to inhibit the transfer of thermal energy from a cell packet of a cell stack to an enclosure cover of the traction battery pack. The cell packet may be arranged between a first structural thermal barrier assembly and a second structural thermal barrier assembly of the cell stack. The thermal barrier shield may be supported at a position between the enclosure cover and the cell packet by the first structural thermal barrier assembly and the second structural thermal barrier assembly.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to thermal barrier shields for use within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, an enclosure assembly including an enclosure cover, a battery cell stack positioned within the enclosure assembly and including a cell packet arranged between a first structural thermal barrier assembly and a second structural thermal barrier assembly, and a thermal barrier shield supported at a position between the enclosure cover and the cell packet by the first structural thermal barrier assembly and the second structural thermal barrier assembly.

In a further non-limiting embodiment of the foregoing traction battery pack, each of the first structural thermal barrier assembly and the second structural thermal barrier assembly includes a thermal barrier fin.

In a further non-limiting embodiment of either of the foregoing traction battery packs, the thermal barrier fin is a pultrusion having a T-shaped cross-section.

In a further non-limiting embodiment of any of the foregoing traction battery packs, the thermal barrier fin includes a polymer composite structure.

In a further non-limiting embodiment of any of the foregoing traction battery packs, the polymer composite structure includes a glass fiber reinforced polypropylene with an intumescent additive.

In a further non-limiting embodiment of any of the foregoing traction battery packs, the thermal barrier fin is flanked by aerogel layers and foam layers to establish a multi-layer sandwich structure.

In a further non-limiting embodiment of any of the foregoing traction battery packs, each of the first structural thermal barrier assembly and the second structural thermal barrier assembly includes an upper interfacing structure configured to interface with the enclosure cover.

In a further non-limiting embodiment of any of the foregoing traction battery packs, the upper interfacing structure includes a basin configured to receive an adhesive.

In a further non-limiting embodiment of any of the foregoing traction battery packs, the basin extends between upwardly extending walls of the upper interfacing structure.

In a further non-limiting embodiment of any of the foregoing traction battery packs, a tab projects in an outboard direction away from each of the upwardly extending walls.

In a further non-limiting embodiment of any of the foregoing traction battery packs, the tab provides a shelf that is configured to support the thermal barrier shield.

In a further non-limiting embodiment of any of the foregoing traction battery packs, a leg of the thermal barrier shield extends from the shelf of the tab of the first structural thermal barrier assembly to the shelf of the tab of the second structural thermal barrier assembly.

In a further non-limiting embodiment of any of the foregoing traction battery packs, the thermal barrier shield extends within a plane that is vertically below the basin.

In a further non-limiting embodiment of any of the foregoing traction battery packs, the thermal barrier shield is constructed from mica.

In a further non-limiting embodiment of any of the foregoing traction battery packs, the thermal barrier shield includes a plurality of cut-outs that establish an outer frame and a plurality of legs that connect between opposing longitudinal sections of the outer frame of the thermal barrier shield.

A traction battery pack according to another exemplary aspect of the present disclosure includes, among other things, an enclosure cover and a structural thermal barrier assembly including a thermal barrier fin configured to establish a first sealed interface relative to the enclosure cover. The thermal barrier fin includes an upper interfacing structure that includes a basin that extends between upwardly extending walls of the upper interfacing structure, and a tab that projects in an outboard direction away from each of the upwardly extending walls. An adhesive is received within the basin, and a thermal barrier shield is supported by the tab of the upper interfacing structure.

In a further non-limiting embodiment of the foregoing traction battery pack, the thermal barrier fin is a pultruded structure of the structural thermal barrier assembly.

In a further non-limiting embodiment of either of the foregoing traction battery packs, the tab includes a shelf that is configured to support the thermal barrier shield at a position that is vertically lower than the basin.

In a further non-limiting embodiment of any of the foregoing traction battery packs, the thermal barrier shield extends from the tab to a second tab of a second thermal barrier fin of a second structural thermal barrier assembly.

In a further non-limiting embodiment of any of the foregoing traction battery packs, the thermal barrier shield is constructed from mica.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 illustrates a cell stack of a traction battery pack.

FIG. 4 is a partial cross-sectional perspective view of the cell stack of FIG. 3.

FIG. 5 is a partial cross-sectional view of the cell stack of FIG. 3.

FIG. 6 illustrates an exemplary thermal barrier shield of a traction battery pack.

FIG. 7 illustrates select portions of another exemplary cell stack of a traction battery pack.

### DETAILED DESCRIPTION

This disclosure details thermal barrier shields for traction battery packs. The thermal barrier shield may be arranged to inhibit the transfer of thermal energy from a cell packet of a cell stack to an enclosure cover of the traction battery pack. The cell packet may be arranged between a first structural thermal barrier assembly and a second structural thermal barrier assembly of the cell stack. The thermal barrier shield may be supported at a position between the enclosure cover and the cell packet by the first structural thermal barrier assembly and the second structural thermal barrier assembly. These and other features are discussed in greater detail in the following paragraphs of this detailed description.

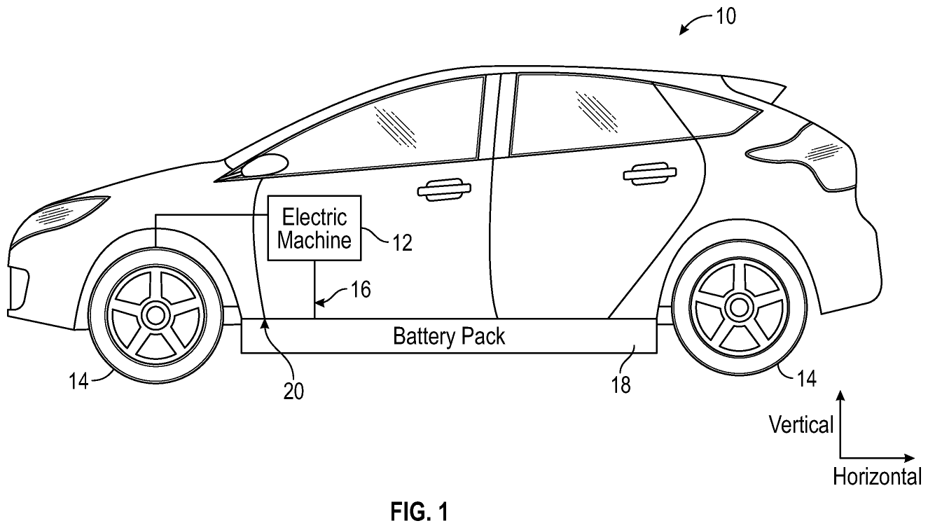

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

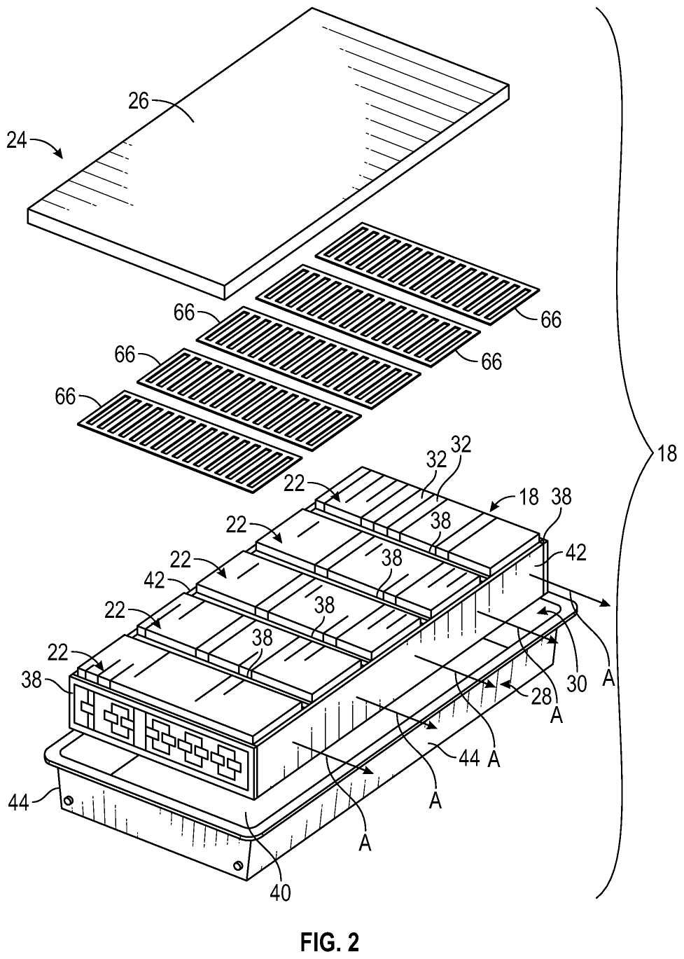

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together side-by-side to one another along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals that project outwardly from a battery cell housing. The tab terminals of the battery cells 32 of each cell stack 22 are connected to one another, such as by one or more busbars, for example, in order to provide the voltage and power levels necessary for achieving vehicle propulsion.

The battery cells 32 of each cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The cell stacks 22 may be arranged to extend along their respective cell stack axes A between opposing end plates 42. One or more end plates 42 may be positioned between each end of each cell stack 22 and a longitudinally extending side wall 44 of the enclosure tray 28. The end plates 42 may therefore extend along axes that are substantially transverse (e.g. perpendicular) to the cell stack axes A of the cell stacks 22 and the cross-member assemblies 38. In some implementations, the end plates 42 are structural members that span across a majority of the length of the longitudinally extending side wall 44 of the enclosure tray 28. However, other configurations are contemplated within the scope of this disclosure.

In an embodiment, the cell stacks 22 and the cross-member assemblies 38 extend longitudinally in a cross-vehicle direction of the electrified vehicle 10, and the end plates 42 extend longitudinally in a length-wise direction of the electrified vehicle 10. However, other configurations are contemplated within the scope of this disclosure.

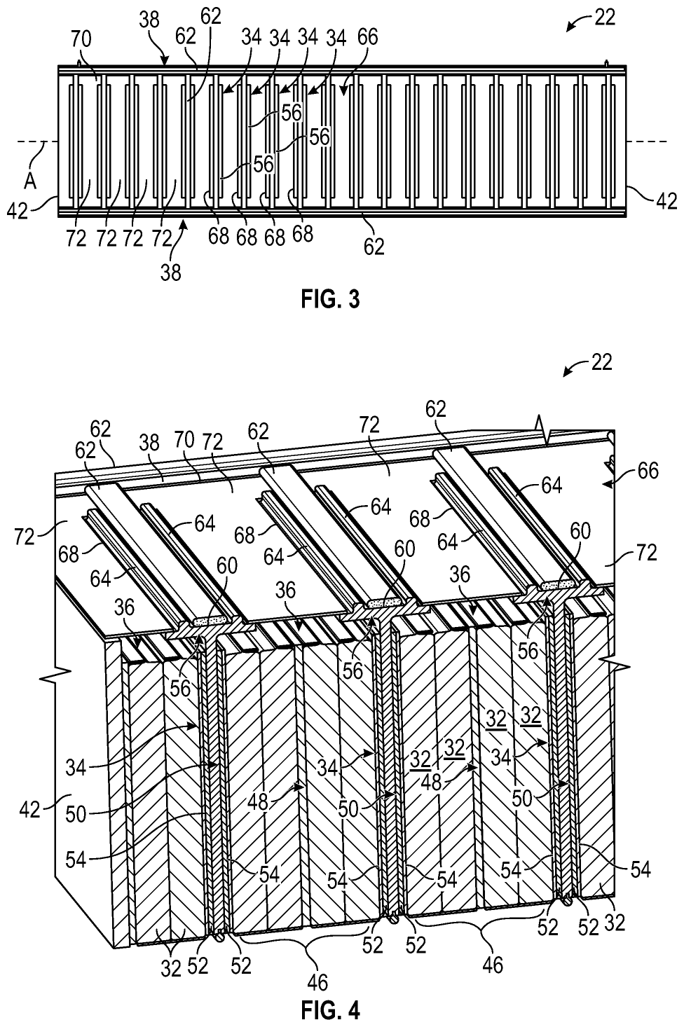

Referring now to FIGS. 2, 3, 4, 5, and 6, with continued reference to FIG. 1, one or more structural thermal barrier assemblies 34 may be arranged along the respective cell stack axis A of each cell stack 22. The structural thermal barrier assemblies 34 may compartmentalize each cell stack 22 into two or more groupings or compartments 36 of battery cells 32.

A cell packet 46 may be positioned within each compartment 36 of the cell stack 22. Each cell packet 46 may be separated from a neighboring cell packet 46 by one of the structural thermal barrier assemblies 34. Each cell packet 46 may include a plurality of battery cells 32 and a cell expansion pad 48 arranged between immediately neighboring battery cells 32 within the cell packet 46. The cell expansion pads 48 may include a material(s) adapted for accommodating battery cell swelling. The material may include polyurethane foam or silicone foam, for example. However, other materials or combinations of materials could be utilized to provide the cell expansion pads 48 with battery swelling accommodating properties within the scope of this disclosure.

Should, for example, a battery thermal event occur in one of the cell packets 46, the structural thermal barrier assemblies 34 may reduce or even prevent thermal energy associated with the thermal event from moving from cell-to-cell, compartment-to-compartment, and/or cell stack-to-cell stack, thereby inhibiting the transfer of thermal energy inside the traction battery pack 18. The structural thermal barrier assemblies 34 may further be configured to structurally join battery structures to increase the structural integrity of the traction battery pack 18.

Each structural thermal barrier assembly 34 may include a thermal barrier fin 50 that is flanked by aerogel layers 52 and foam layers 54 as part of a multi-layer sandwich structure of the structural thermal barrier assembly 34. The thermal barrier fin 50 may include a polymer composite structure (e.g., glass fiber reinforced polypropylene with an intumescent additive), the aerogel layers 52 may be encapsulated aerogel layers that include aerogel, a metallic sublayer (e.g., stainless steel), polyethylene terephthalate (PET) sublayers, and adhesive sublayers, and the foam layers 54 may include polyurethane foam or silicone foam, for example. However, other materials or combinations of materials could be utilized to construct the subcomponents of the structural thermal barrier assembly 34 within the scope of this disclosure

The thermal barrier fin 50 may be a pultrusion, which implicates structure to this component. A person of ordinary skill in the art having the benefit of this disclosure would understand how to structurally distinguish a pultruded structure from another type of structure, such as an extrusion, for example. The thermal barrier fin 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the thermal barrier fin 50. In other implementations, the thermal barrier fin 50 could be an injection molded part or an extruded part.

The thermal barrier fin 50 may include a T-shaped cross-section. However, other shapes are contemplated within the scope of this disclosure.

The thermal barrier fin 50 of each structural thermal barrier assembly 34 may include an upper interfacing structure 56 that is configured to interface with the enclosure cover 26 or an intermediate structure (e.g., a heat exchanger plate) that is positioned between the structural thermal barrier assembly 34 and the enclosure cover 26. The upper interfacing structure 56 may include a dish-like basin 60 for receiving and holding an adhesive 62. The basin 60 may be established by upwardly extending walls 64 of the upper interfacing structure 56. The adhesive 62 may be utilized to secure each structural thermal barrier assembly 34 to the enclosure cover 26. The adhesive 62 may be an epoxy based adhesive or a urethane based adhesive, for example. Once the upper interfacing structures 56 are secured relative to the enclosure cover 26, the structural thermal barrier assemblies 34 substantially prevent thermal energy from moving from one compartment 36 to another at the sealed interfaces between the structural thermal barrier assemblies 34 and the enclosure cover 26, such as during a battery thermal event, for example.

An additional amount of the adhesive 62 may be utilized to secure the cross-member assemblies 38 and/or the end plates 42 to the enclosure cover 26. Once the adhesive 62 cures, the cell stack 22 and the enclosure cover 26 are effectively structurally coupled to one another, thereby increasing the structural stiffness of the traction battery pack 18.

A thermal barrier shield 66 may be arranged axially between the cell stack 22 and the enclosure cover 26 for managing/mitigating any thermal influence on the enclosure cover 26 during battery thermal events. For example, the thermal barrier shield 66 may be arranged to shield the enclosure cover 26 from thermal energy created when one or more battery cells 32 of one or more of the cell packets 46 release battery vent gases and/or other effluents during the battery thermal event. The thermal barrier shield 66 may limit or even prevent the battery vent gases and/or effluents from influencing the structural integrity of the enclosure cover 26 and/or the adhesive 62.

In an embodiment, the thermal barrier shield 66 is constructed from mica. However, other flame resistant and heat insulating materials could be utilized within the scope of this disclosure.

The thermal barrier shield 66 may include a plurality of cut-outs 68 that are sized to accommodate the upper interfacing structure 56 of the thermal barrier fin 50 of each structural thermal barrier assembly 34 of the cell stack 22. The thermal barrier shield 66 may therefore be installed over top of the cell stack 22 as a single piece.

The cut-outs 68 may configure the thermal barrier shield 66 to include an outer frame 70 and a plurality of legs 72 that connect between opposing longitudinal sections of the outer frame 70. When the thermal barrier shield 66 is arranged over the cell stack 22, the legs 72 of the thermal barrier shield 66 extend over top of the cell packets 46 of the cell stack 22. The legs 72 therefore substantially isolate the enclosure cover 26 from the cell packets 46.

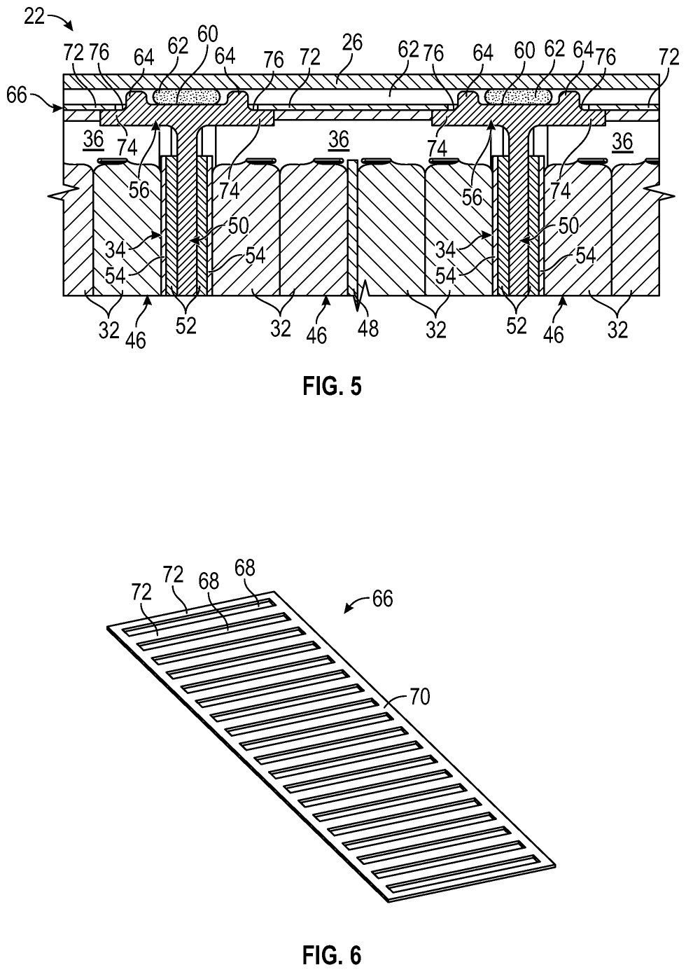

The legs 72 of the thermal barrier shield 66 may be supported by the upper interfacing structures 56 of adjacent thermal barrier fins 50. For example, as best shown in FIG. 5, each upper interfacing structure 56 may include tabs 74 that project in an outboard direction away from the upwardly extending walls 64. Each tab 74 may establish a shelf 76 for supporting one of the legs 72 of the thermal barrier shield 66. Each leg 72 may therefore extend from the tab 74 of one thermal barrier fin 50 to the tab 74 of another thermal barrier fin 50 at a position that is directly over top of one of the cell packets 46 of the cell stack 22.

Each shelf 76 may extend within a plane that is vertically lower than the basin 60 of each upper interfacing structure 56. Thus, when the thermal barrier shield 66 is arranged over the cell stack 22, the legs 72 are positioned vertically lower than the adhesive 62, thereby maintaining a consistent height at which the adhesive interfaces with the enclosure cover 26 during assembly.

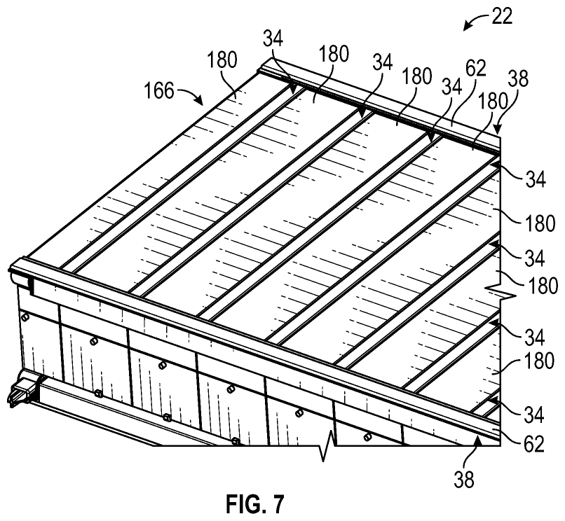

FIG. 7 illustrates another exemplary thermal barrier shield 166 that can be utilized within the traction battery pack 18 described above. In this embodiment, rather than being configured as a single-piece structure, the thermal barrier shield 166 may be established by a plurality of individual thermal barrier strips 180 that can be arranged to extend over top of the cell packets 46 of the cell stack 22. In this implementation, the thermal barrier strips 180 are supported by adjacent structural thermal barrier assemblies 34 of the cell stack 22 but are unconnected to one another by an outer frame.

The thermal barrier shields of this disclosure may be arranged to establish an intermediate barrier between the cell packets of a cell stack and an enclosure cover in order to protect the cover from hot gases/effluents and their associated heat without compromising adhesive retention and sealing. The exemplary thermal barrier shields may be provided in either single piece or multiple piece constructions that can be supported over top of the cell packets by structural thermal barrier assemblies of the cell stack, thereby simplifying assembly.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
an enclosure assembly including an enclosure cover;
a battery cell stack positioned within the enclosure assembly and including a cell packet arranged between a first structural thermal barrier assembly and a second structural thermal barrier assembly; and
a thermal barrier shield supported at a position between the enclosure cover and the cell packet by the first structural thermal barrier assembly and the second structural thermal barrier assembly.

2. The traction battery pack as recited in claim 1, wherein each of the first structural thermal barrier assembly and the second structural thermal barrier assembly includes a thermal barrier fin.

3. The traction battery pack as recited in claim 2, wherein the thermal barrier fin is a pultrusion having a T-shaped cross-section.

4. The traction battery pack as recited in claim 2, wherein the thermal barrier fin includes a polymer composite structure.

5. The traction battery pack as recited in claim 4, wherein the polymer composite structure includes a glass fiber reinforced polypropylene with an intumescent additive.

6. The traction battery pack as recited in claim 2, wherein the thermal barrier fin is flanked by aerogel layers and foam layers to establish a multi-layer sandwich structure.

7. The traction battery pack as recited in claim 1, wherein each of the first structural thermal barrier assembly and the second structural thermal barrier assembly includes an upper interfacing structure configured to interface with the enclosure cover.

8. The traction battery pack as recited in claim 7, wherein the upper interfacing structure includes a basin configured to receive an adhesive.

9. The traction battery pack as recited in claim 8, wherein the basin extends between upwardly extending walls of the upper interfacing structure.

10. The traction battery pack as recited in claim 9, comprising a tab that projects in an outboard direction away from each of the upwardly extending walls.

11. The traction battery pack as recited in claim 10, wherein the tab provides a shelf that is configured to support the thermal barrier shield.

12. The traction battery pack as recited in claim 11, wherein a leg of the thermal barrier shield extends from the shelf of the tab of the first structural thermal barrier assembly to the shelf of the tab of the second structural thermal barrier assembly.

13. The traction battery pack as recited in claim 8, wherein the thermal barrier shield extends within a plane that is vertically below the basin.

14. The traction battery pack as recited in claim 1, wherein the thermal barrier shield is constructed from mica.

15. The traction battery pack as recited in claim 1, wherein the thermal barrier shield includes a plurality of cut-outs that establish an outer frame and a plurality of legs that connect between opposing longitudinal sections of the outer frame of the thermal barrier shield.

16. A traction battery pack, comprising:
an enclosure cover;
a structural thermal barrier assembly including a thermal barrier fin configured to establish a first sealed interface relative to the enclosure cover;
the thermal barrier fin including an upper interfacing structure that includes a basin that extends between upwardly extending walls of the upper interfacing structure and a tab that projects in an outboard direction away from each of the upwardly extending walls;
an adhesive received within the basin; and
a thermal barrier shield supported by the tab of the upper interfacing structure.

17. The traction battery pack as recited in claim 16, wherein the thermal barrier fin is a pultruded structure of the structural thermal barrier assembly.

18. The traction battery pack as recited in claim 16, wherein the tab includes a shelf that is configured to support the thermal barrier shield at a position that is vertically lower than the basin.

19. The traction battery pack as recited in claim 16, wherein the thermal barrier shield extends from the tab to a second tab of a second thermal barrier fin of a second structural thermal barrier assembly.

20. The traction battery pack as recited in claim 16, wherein the thermal barrier shield is constructed from mica.
